(19) United States
(12) Patent Application Publication
(10) Pub. No.: US 2012/0036930 A1
(43) Pub. Date: Feb. 16, 2012

(54) EXTRUSION-COATING METHOD FOR A SENSOR DEVICE AND SENSOR DEVICE

(76) Inventor: Peter Kunert, Lichtenstein (DE)

(21) Appl. No.: 13/207,890

(22) Filed: Aug. 11, 2011

(30) Foreign Application Priority Data
Aug. 13, 2010 (DE) 102010039329.0

(51) Int. Cl. G01P 15/00; B05D 5/00; B05D 3/12

(52) U.S. Cl. 73/488; 427/355; 427/58

(57) ABSTRACT

An extrusion-coating method for a sensor device, including the following steps:
providing a sensor module, which is completely enclosed by a first medium,
supporting by a support bar on the first medium of the sensor module,
extrusion-coating the sensor module using a second medium, so that a sealing connection is formed between the first medium and the second medium and
extracting the support bar. Also, a sensor device.

### BACKGROUND INFORMATION

It is known that sensors may be extrusion-coated with an elastomer to form an elastomer sheathing around the sensor. To contact the extrusion-coated sensor electrically, an electrical plug contact of the sensor is not completely extrusion-coated in the known methods. This means that this plug contact remains partially exposed and protrudes from the elastomer sheathing. In a second extrusion-coating step, the elastomer sheathing is extrusion-coated with a thermoplastic to form a thermoplastic housing. To ensure trouble-free operation of the sensor, the sensor must be situated in a precisely defined position in the thermoplastic housing. This is achieved in particular by a support bar, which supports the elastomer sheathing on the protruding plug contact. The support bar is pulled during the thermoplastic extrusion-coating. The point in time of pulling of the support bar thus determines both the positional accuracy of the sensor and the imperviousness of the thermoplastic sheathing, which determines the robustness of the sensor over its lifetime. Such a method is described in German Patent No. DE 10 2007 057 441.

### SUMMARY OF THE INVENTION

An object of the present invention is to provide an extrusion-coating method for a sensor device, which ensures improved imperviousness of the sensor device while ensuring improved positional accuracy.

In addition, an object of the present invention is to provide a sensor device which has reliable imperviousness with respect to external influences.

These objects are achieved by an extrusion-coating method and by a sensor device according to the present invention.

The present invention includes the idea of providing an extrusion-coating method for a sensor device such that a sensor module, which is completely enclosed by a first medium, is provided in a first step. It is possible in particular for the sensor module to be completely extrusion-coated by the first medium. Thus, in contrast to the related art, no plug contacts of the sensor module protrude from the sheathing formed by the first medium, for example.

In a second step, a support bar supports the first medium of the sensor module. For example, the support bar may act on support areas of the sheathing. In particular, the support areas may be designed in such a way that they correspond to a negative impression with respect to the shape of the support bar. Thus, the support bar may support the first medium in a particularly reliable manner. In another exemplary specific embodiment, the first medium may also be supported in additional areas, for example, by additional support bars.

In the next step, the sensor module is extrusion-coated using a second medium, the support bar continuously supporting the first medium during this extrusion-coating step, so that high positional accuracy of the sensor module in the second medium is achieved. The first and the second medium form a sealing connection which ensures permanent imperviousness of the sensor module with respect to external environmental influences.

After the sheathing of the sensor module has been extrusion-coated using the second medium, the support bar is extracted.

The present invention also includes the idea of providing a sensor device having a sensor module, the sensor module being completely enclosed by a first medium. Furthermore, a second medium which partially surrounds the first medium is provided so that a support area for a support bar remains exposed. The sensor device may be manufactured using the extrusion-coating method in particular.

According to a preferred embodiment of the present invention, a first medium having hollow spheres with a hydrocarbon fluid is used. Fluid here includes both a gas and a liquid. The hydrocarbon preferably includes pentane or octane. The hollow spheres have in particular a diameter of 10 μm to 40 μm. According to a particularly preferred embodiment, the hollow spheres are formed from an outer sheathing, in particular a thermoplastic sheathing. The hollow spheres are preferably homogeneous. This means, for example, that they have the same features and same properties. Alternatively, the hollow spheres are not homogeneous.

According to another exemplary specific embodiment of the present invention, a plug unit is electrically connected to the sensor module before and/or during the extrusion-coating of the sheathing of the sensor module using the second medium. The sensor module preferably includes an insert part and a sensor situated on the insert part, the first medium completely enclosing both the insert part and the sensor in particular. The insert part is also formed in particular so that electrical contacting of the sensor module is made possible in this way. For example, the insert part includes a circuit board. An electrical connection between the plug unit and the sensor may then be accomplished via the insert part.

According to another preferred specific embodiment, the plug unit includes another insert part. The additional insert part is preferably connected to the insert part of the sensor module and held by an insert part holder. The insert part holder here holds the insert part and the additional insert part. For example, the insert part holder as an injection-molded component, in particular as a preliminary extrusion-coated part, may be injected around the insert part and the additional insert part. For example, the insert part of the sensor module may be brought into electrical contact with the additional insert part of the plug unit before the sensor module is enclosed by the first medium, in particular by extrusion-coating. The insert part holder is then molded around the insert part and the additional insert part. Next the sensor module, i.e., the sensor and the insert part, are completely enclosed by the first medium, in particular by extrusion-coating, the insert part holder being at least partially surrounded by the first medium, in particular by extrusion-coating. This means that the insert part holder is situated or embedded at least partially in the sheathing formed by the first medium. The insert part holder is preferably embedded completely in the sheathing. During the extrusion-coating step of the sensor module with the second medium, the insert part holder, the additional insert part and the plug unit are also extrusion-coated. However, an area of the plug unit is left exposed here, so that access to the additional insert part from the outside is made possible via the plug unit. The insert part and the additional insert part may also be referred to as electrical plug contacts.

According to another preferred specific embodiment, a bushing is formed in the second medium during the extrusion-coating of the sensor module. For example, the housing formed by the second medium may be secured by the bushing, for example, in a motor vehicle.

In another exemplary embodiment, the first medium and/or the second medium is/are formed from a material selected from the following group of materials: elastomer, thermoplastic, thermoplastic elastomer, polymer having an elastomer backing, polyurethane, silicone, liquid silicone or a combination thereof. In particular a silicone may be used with an adhesion promoter and/or an adhesion-modified thermoplastic elastomer. Furthermore, the materials may preferably include a primer. The aforementioned materials are preferably formed as foam, for example, as an elastomer foam, a silicone foam or a thermoplastic foam. In general, such materials, which enter into a physical and/or chemical bond with one another, are preferred for use here. Because of this bond, a tight connection is formed between the first and the second medium, so that good imperviousness of the sensor module is ensured in particular.

According to a particularly preferred specific embodiment, a particularly hard material is used for the first medium. It is possible in this way to influence in a targeted manner the extent to which the sheathing formed by the first medium may yield to the support bar during extrusion-coating using the second medium.

According to another exemplary embodiment, the sensor device may be used in an airbag sensor system of a motor vehicle. The sensor preferably includes an acceleration sensor, for example, a PAS (“peripheral acceleration sensor”) airbag sensor and/or a pressure sensor. However, the sensor device may preferably also be used in airbag sensor systems for personal safety clothing, for example, a cycling suit having one or more integrated airbags.

### BRIEF DESCRIPTION OF THE DRAWINGS

FIG. 1 shows a sensor device according to the related art.

FIG. 2 shows a sensor device according to the present invention during extrusion-coating.

FIG. 3 shows the sensor device from FIG. 2 after extrusion-coating.

FIG. 4 shows a detailed view of the sensor device from FIG. 3.

FIG. 5 shows a flow chart of a specific embodiment of the extrusion-coating method according to the present invention.

### DETAILED DESCRIPTION

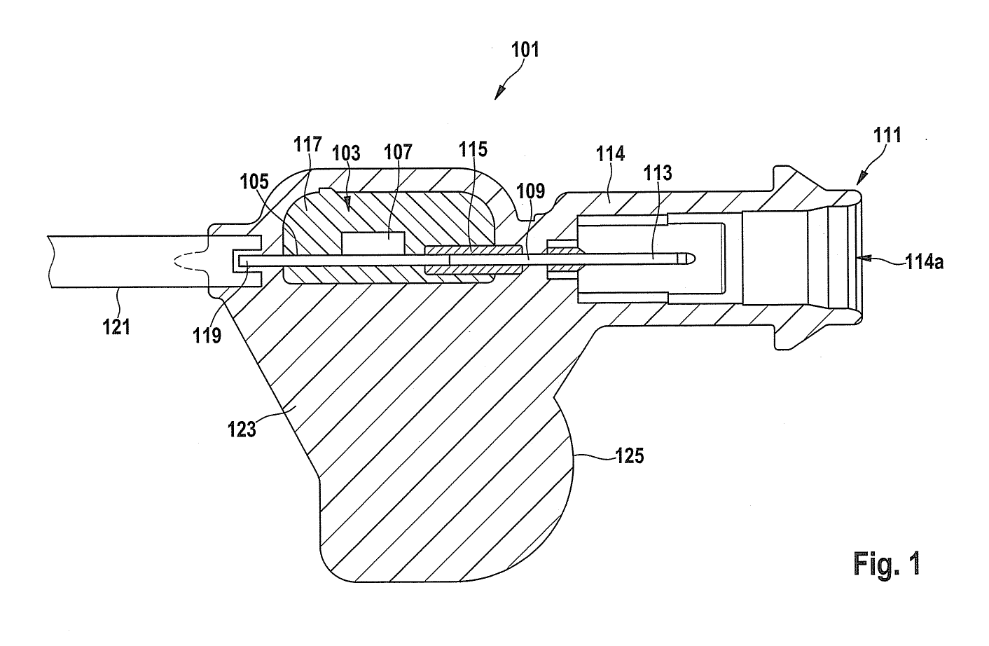

FIG. 1 shows a sensor device 101 according to the related art during an extrusion-coating step according to a known extrusion-coating method. Sensor device 101 includes a sensor module 103. Sensor module 103 has an insert part 105 and a sensor 107 situated on insert part 105. Insert part 105 is preferably formed in such a way that electrical contacting of sensor 107 via insert part 105 is made possible. For example, insert part 105 may be formed as a circuit board. Another insert part 109 is situated on insert part 105, contacting insert part 105, so that an electrical connection is formed between insert part 105 and additional insert part 109. Insert part 109 is part of a plug unit 111 and transitions into a pin 113, which is situated in a plug housing 114. Plug housing 114 has an opening 114a, through which pin 113 is accessible from the outside. Insert part 105 and additional insert part 109 are held by an insert part holder 115. Insert part 105 and additional insert part 109 form electrical plug contacts.

Sensor module 103 is partially enclosed by a first medium 117. In other words, insert part 105 of sensor module 103 protrudes from first medium 117. The area of insert part 105, which protrudes from first medium 117, is labeled with reference numeral 119. First medium 117 also partially surrounds insert part holder 115, so that insert part holder 115 protrudes from first medium 117.

A support bar 121 engages with protruding area 119 of insert part 105 and thereby supports insert part 105 as well as sensor module 103. A second medium 123 is injected around sensor module 103 and plug unit 111, thereby forming a housing 125 around sensor module 103 and plug housing 114, with pin 113 of plug unit 111 remaining accessible from the outside of housing 125 through opening 114a of plug housing 114 for the purpose of electrical contacting. During the extrusion-coating, support bar 121 is pulled away from protruding area 119 of insert part 105. A resulting clearance is filled with second medium 123.

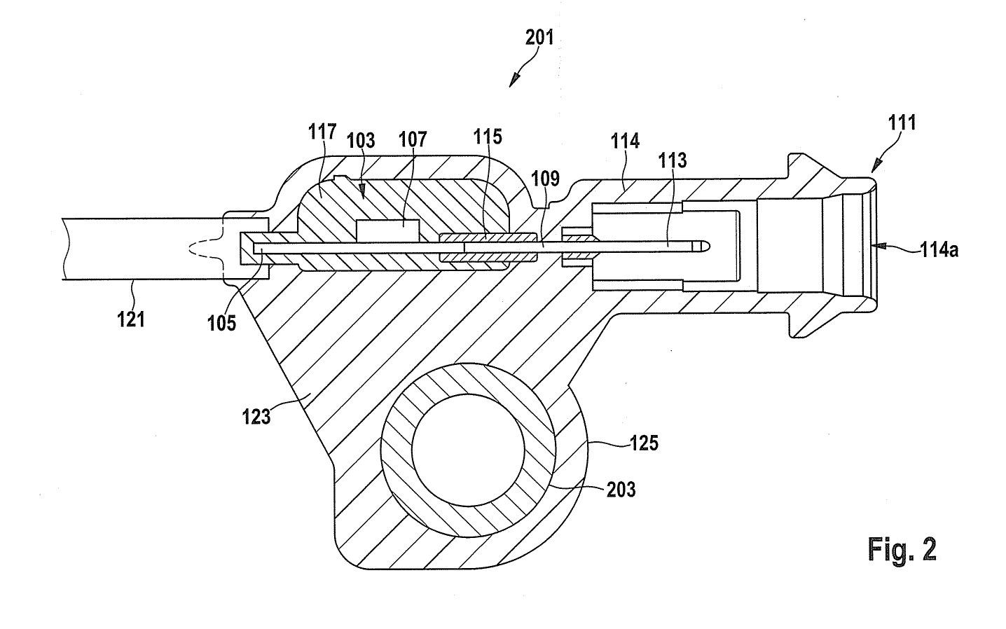

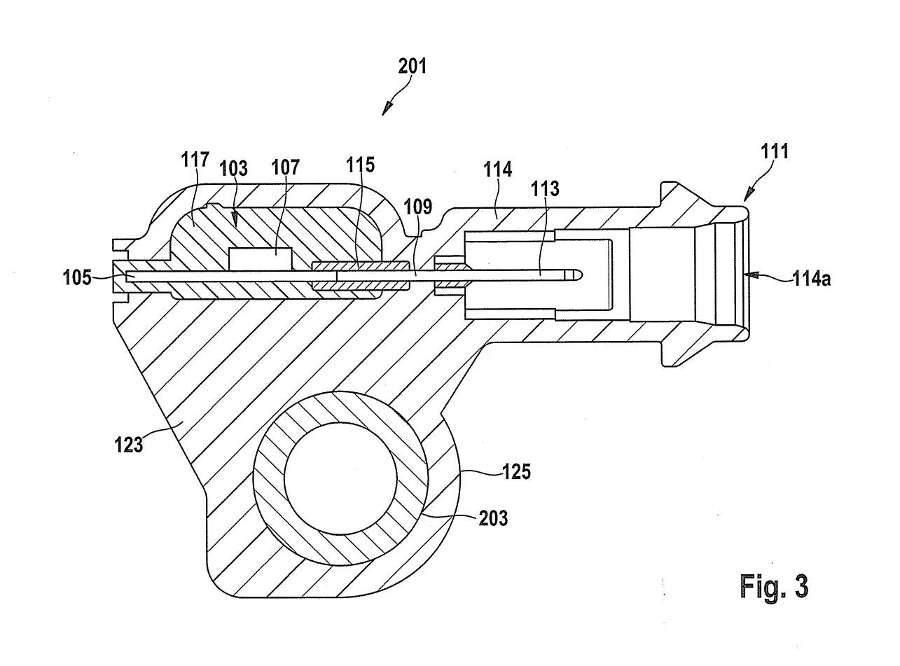

FIG. 2 shows a sensor device 201 according to the present invention during an extrusion-coating step of the extrusion-coating method according to the present invention. In contrast to known sensor device 101 in FIG. 1, insert part 105 of sensor module 103 is completely enclosed by first medium 117. In other words, insert part 105 does not protrude from first medium 117. Therefore, support bar 121 does not support sensor module 103 on insert part 105 but instead supports it directly on first medium 117. This support is accomplished during the entire extrusion-coating step. Support bar 121 is extracted only after housing 125, which is formed by second medium 123, is completed. FIG. 3 shows sensor device 201 after support bar 121 has been extracted. It is clearly apparent here that insert part 105 is cushioned against external environmental influences because it is completely surrounded by first medium 117.

Sensor device 201 also has a bushing 203, which is formed during the extrusion-coating. Sensor device 201 may be secured by bushing 203, for example, in a motor vehicle.

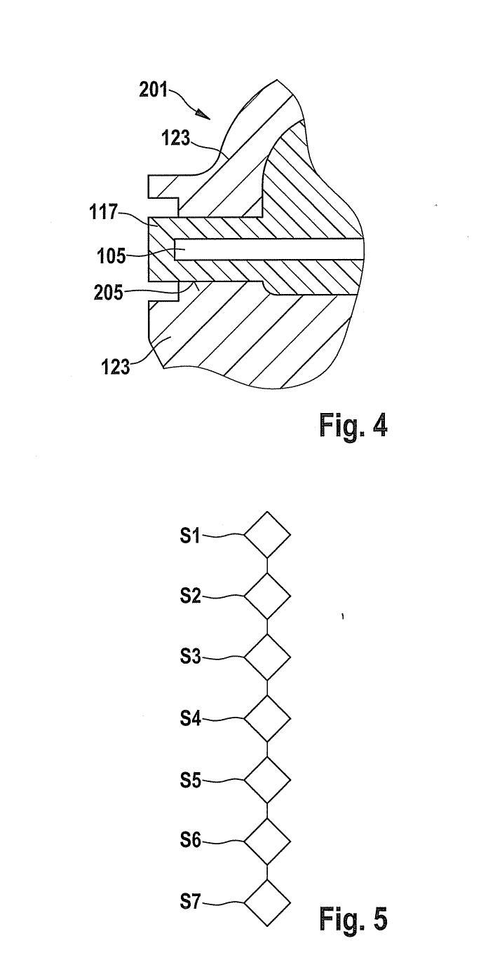

FIG. 4 shows a detailed view of sensor device 201 after support bar 121 has been extracted from sensor module 103. Because of the suitable choice of material of first medium 117 and of second medium 123, a sealing connection is formed in the area of a sealing face 205 between first medium 117 and second medium 123. First medium 117 and second medium 123 here enter into a physical and/or chemical bond, forming a tight connection between the two media 117 and 123. First medium 117 preferably includes an elastomer and second medium 123 includes a thermoplastic. In particular, an adhesion-modified thermoplastic elastomer or a silicone having a corresponding surface treatment, for example, an adhesion promoter, may also be used for first medium 117. In an exemplary embodiment, which is not shown here, the first medium has hollow spheres having a carbon fluid.

The tight connection between first medium 117 and second medium 123 is formed here via a basic material or an adhesion promoter of first medium 117.

FIG. 5 shows a flow chart of a preferred specific embodiment of the extrusion-coating method according to the present invention. In a first step S1, sensor module 103 having insert part 105 and sensor 107 is provided. In a second step S2, plug unit 111 is positioned on sensor module 103, so that additional insert part 109 is in contact with insert part 105 for the purpose of electrical contacting. Both insert parts 105 and 109 are extrusion-coated in next step S3, for example, using a material which may also be used for first medium 117 or second medium 123. Insert part holder 115 is formed by this extrusion-coating, thereby creating a fixed connection between sensor module 103 and plug unit 111.

In the next step S4, sensor module 103 is extrusion-coated using first medium 117, so that sensor module 103 is completely enclosed by first medium 117.

Next, in a step S5, support bar 121 is moved toward sensor module 103 so that support bar 121 supports sensor module 103 on first medium 117. According to another exemplary embodiment of the extrusion-coating method, an additional support bar may additionally support sensor module 103 on first medium 117 in step S5.

In a next step S6, sensor module 103, insert part holder 115, additional insert part 109 and plug housing 114 are extrusion-coated using second medium 123, so that a sealing connection is formed between the two media 117 and 123. However, opening 114a is left exposed here. During step S6, support bar 121 supports sensor module 103 continuously, thereby ensuring an accurate position of sensor module 103 in housing 125 formed by second medium 123. In contrast, there is the possibility with the known extrusion-coating methods of the related art that sensor module 103 changes its position in housing 125 because support bar 121 has already been extracted during extrusion-coating using second medium 123. The extrusion-coating method according to the present invention waits until housing 125 is completed, in particular until the second medium has cured, so that sensor module 103 is no longer able to change its position in housing 125.

Next in a step S7, support bar 121 is extracted from first medium 117. Since sensor module 103 is already completely enclosed by first medium 117, no more material needs to be injected around sensor module 103 after the extraction of support bar 121, which advantageously saves time and material in particular.

The extrusion-coating method according to the present invention is based on extrusion-coating of a sensor module using two media. Therefore, the extrusion-coating method may also be referred to as a direct two-component extrusion-coating method. The extrusion-coating method according to the present invention may be used not only for the extrusion-coating of sensor modules but also for all micromechanical components which are suitable for such an extrusion-coating method. The extrusion-coating method according to the present invention is preferably performed in a special two-component extrusion-coating die, which ensures a continuous manufacturing process.

What is claimed is:

1. An extrusion-coating method for a sensor device, comprising:
providing a sensor module which is completely enclosed by a first medium;
supporting by a support bar on the first medium of the sensor module;
extrusion-coating the sensor module with a second medium, so that a sealing connection is formed between the first medium and the second medium; and
extracting the support bar.

2. The extrusion-coating method according to claim 1, wherein the first medium has hollow spheres with a hydrocarbon fluid.

3. The extrusion-coating method according to claim 1, further comprising electrically connecting a plug unit to the sensor module before and/or during the extrusion-coating of the sensor module.

4. The extrusion-coating method according to claim 1, further comprising forming a bushing in the second medium during the extrusion-coating.

5. A sensor device, comprising:
a support bar;
a sensor module;
a first medium completely surrounding the sensor module; and
a second medium partially surrounding the first medium, so that a support area for the support bar remains exposed.

6. The sensor device according to claim 5, wherein the sensor module includes an insert part and a sensor situated on the insert part.

7. The sensor device according to claim 6, further comprising a plug unit which is electrically connected to the sensor module and is formed in the second medium.

8. The sensor device according to claim 7, wherein the plug unit includes another insert part which is connected to the insert part of the sensor module by an insert part holder.

9. The sensor device according to claim 5, wherein hollow spheres having a hydrocarbon fluid are situated in the first medium.

10. The sensor device according to claim 5, wherein at least one of the first medium and the second medium is formed from a material selected from the following group of materials: elastomer, thermoplastic, thermoplastic elastomer, polymer having an elastomer backing, polyurethane, silicone, liquid silicone or a combination thereof.
